(19) United States
(12) Patent Application Publication
(10) Pub. No.: US 2010/0010121 A1
(43) Pub. Date: Jan. 14, 2010

(54) Ink composition, recording method using the ink composition, ink cartridge

(75) Inventors: Shuichi Koganehira, Matsumoto-shi (JP); Masashi Kamibayashi, Matsumoto-shi (JP); Hironori Sato, Shiojiri-shi (JP)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Seiko Epson Corporation, Tokyo (JP)

(21) Appl. No.: 12/454,937

(22) Filed: May 27, 2009

(30) Foreign Application Priority Data
May 27, 2008 (JP) 2008-138457
May 22, 2009 (JP) 2009-123928

(51) Int. Cl. C09D 11/10

(52) U.S. Cl. 524/90; 524/388

(57) ABSTRACT

An ink composition that can be prevented from aggregating, form an image free from white streaks and harshness even in low-resolution printing, achieve high dissolution of clogging and high-temperature storage stability, and form a high-quality image, particularly an image having excellent hue is provided.

An ink composition that contains at least a pigment, water, an alcohol solvent, a dispersant, and a surfactant, in which the alcohol solvent contains a poorly water-soluble alkane diol, a water-soluble 1,2-alkane diol optionally having a branched chain, and a water-soluble 1,3-alkane diol or alkylene glycol optionally having a branched chain, and the dispersant contains an oxyethyl acrylate resin, is used in an ink jet recording method.

### CROSS-REFERENCES TO RELATED APPLICATIONS

The entire disclosure of Japanese Patent Application No. 2008-138457, filed on May 27, 2008, and No. 2009-123928, filed on May 22, 2009, are expressly incorporated by reference herein.

### FIELD OF THE INVENTION

The present invention relates to an ink composition that can be prevented from aggregating, form an image free from white streaks and harshness even in low-resolution printing, achieve high dissolution of clogging and high-temperature storage stability, and form a high-quality image, particularly an image having excellent hue.

### BACKGROUND OF THE INVENTION

In recent years, with the spread of image forming technology using digital data, desktop publishing (DTP) has become increasingly common particularly in the field of printing. Even in printing in DTP, color proofs are prepared in advance to check the gloss and the color of an actual printed matter. An ink jet recording method has been used to output such proofs. Because color reproduction and stability reproduction of printed matter are required in DTP, special paper for ink jet recording is generally used as a recording medium.

Special paper for ink jet recording is designed to achieve gloss and color equivalent to those of outputs printed on actual printing paper. Thus, the quality of special paper is appropriately adjusted to the type of actual printing paper. However, manufacture of special paper corresponding to all types of actual printing paper will lead to high manufacturing costs. Thus, in color proof applications, there is a demand that ink jet recording be performed on actual printing paper rather than special paper. If proofs printed directly on actual printing paper rather than special paper by ink jet recording can be used as final proofs, proofreading costs can be reduced greatly. Synthetic paper formed of polyethylene resin or polyester resin blended with inorganic filler, widely used in the field of printing, has excellent recyclability and has received attention as an ecological material in recent years.

Actual printing paper is coated paper that includes a coated layer for receiving an oil-based ink on the surface thereof. However, the coated layer has a poor ink absorption ability. Water-based pigment ink, which is generally used in ink jet recording, therefore penetrates insufficiently into the recording medium (actual printing paper), sometimes causing blurring or uneven aggregation in an image.

To address these problems, for example, JP-A-2005-194500 (Patent Document 1) discloses a pigment ink that contains a polysiloxane compound as a surfactant and an alkane diol, such as 1,2-hexanediol, as a dissolution aid to reduce blurring and have a high gloss on special paper. It is proposed that the addition of glycerin or a diol, such as 1,3-butanediol, (for example, JP-A-2003-213179 (Patent Document 2) and JP-A-2003-253167 (Patent Document 3)) or a triol solvent, such as pentanetriol, (for example, JP-A-2006-249429 (Patent Document 4)) to ink control the penetration of the ink to a recording medium, thus forming high-quality images. JP-A-2007-297595 (Patent Document 5) and JP-A-2007-297596 (Patent Document 6) disclose an ink set that has excellent color reproducibility and gloss in recording on a recording medium.

### Related Art

[Patent Document 1] JP-A-2005-194500

[Patent Document 2] JP-A-2003-213179

[Patent Document 3] JP-A-2003-253167

[Patent Document 4] JP-A-2006-249429

[Patent Document 5] JP-A-2007-297595

[Patent Document 6] JP-A-2007-297596

### SUMMARY OF THE INVENTION

The present inventors recently found that, if an ink composition contains at least a pigment, water, an alcohol solvent, a dispersant, and a surfactant, wherein the alcohol solvent contains a poorly water-soluble alkane diol, a water-soluble 1,2-alkane diol optionally having a branched chain, and a water-soluble 1,3-alkane diol or alkylene glycol optionally having a branched chain, and the dispersant contains an oxyethyl acrylate resin, then the ink composition can be prevented from aggregating, form an image free from white streaks and harshness even in low-resolution printing, achieve high dissolution of clogging and high-temperature storage stability, and form a high-quality image, particularly an image having excellent hue. The invention is based on this finding.

Accordingly, it is an object of the invention to provide an ink composition that can be prevented from aggregating, form an image free from white streaks and harshness even in low-resolution printing, achieve high dissolution of clogging and high-temperature storage stability, and form a high-quality image, particularly an image having excellent hue.

An ink composition according to the invention contains at least a pigment, water, an alcohol solvent, a dispersant, and a surfactant, wherein the alcohol solvent contains a poorly water-soluble alkane diol, a water-soluble 1,2-alkane diol optionally having a branched chain, and a water-soluble 1,3-alkane diol or alkylene glycol optionally having a branched chain, and the dispersant contains an oxyethyl acrylate resin.

The invention can provide an ink composition that can be prevented from aggregating, form an image free from white streaks and harshness even in low-resolution printing, achieve high dissolution of clogging and high-temperature storage stability, and form a high-quality image, particularly an image having excellent hue.

### DETAILED DESCRIPTION OF THE PRESENT INVENTION

An ink composition according to the invention contains at least a pigment, water, an alcohol solvent, a dispersant, and a surfactant, wherein the alcohol solvent contains a poorly water-soluble alkane diol, a water-soluble 1,2-alkane diol optionally having a branched chain, and a water-soluble 1,3-alkane diol or alkylene glycol optionally having a branched chain, and the dispersant contains an oxyethyl acrylate resin. The components will be described below.

### <Definition>

In the present specification, an alkane diol and an alkylene glycol may have a straight chain or a branched chain.

The term “water-soluble” means that water solubility (the amount of solute per 100 g of water) at 20° C. is at least 10.0 g, and the term “poorly water-soluble” means that water solubility (the amount of solute per 100 g of water) is less than 1.0 g.

### <Ink Composition>

Preferably, the pigment contained in an ink composition according to the invention is, but not limited to, a solid solution of C.I. Pigment Red 202 and γ-type C.I. Pigment Violet 19 and/or γ-type C.I. Pigment Violet 19. More preferably, the pigment is a solid solution of γ-type C.I. Pigment Violet 19 and C.I. Pigment Red 202. Use of such a pigment can achieve high dissolution of clogging and high-temperature storage stability.

The term “a solid solution of γ-type C.I. Pigment Violet and C.I. Pigment Red 202”, as used herein, refers to a crystal in which γ-type C.I. Pigment Violet 19 and C.I. Pigment Red 202 are mutually dissolved in a solid state.

The ratio of the amount of γ-type C.I. Pigment Violet 19 to the amount of C.I. Pigment Red 202 in the solid solution can be appropriately controlled within the scope of the invention. Preferably, the weight of γ-type C.I. Pigment Violet 19 is greater than the weight of C.I. Pigment Red 202.

The pigment solid content of an ink composition according to the invention is preferably, but not limited to, 6% by weight or more to ensure color developability in recorded images.

An alcohol solvent for use in an ink composition according to the invention contains at least three organic solvents: a poorly water-soluble alkane diol, a water-soluble 1,2-alkane diol optionally having a branched chain, and a water-soluble 1,3-alkane diol or alkylene glycol optionally having a branched chain. The presence of these three alcohol solvents as essential components can provide an ink composition that is prevented from aggregating and that not only forms a high-quality image free from white streaks and harshness even in low-resolution printing in actual printing paper, particularly art paper, paper for POD applications (for example, Ricoh business coat gloss 100 manufactured by Ricoh Company, Ltd.), and laser printer paper (for example, LPCCTA4 manufactured by Seiko Epson Co.) each having a relatively high ink absorption ability, but also forms a high-quality image free from white streaks and harshness even in printing on a recording medium that has little ink absorption ability, such as a resin film.

The term “aggregation”, as used herein, refers to local unevenness in the density of related colors in printing of an area (for example, in printing of an area of six square inches in monochrome (which does not mean the number of ink colors)), but does not mean that part of a recording medium surface remains uncoated with ink. The term “white streak” means that local unevenness in the color density of related colors in printing of an area (for example, in printing of an area of six square inches in monochrome) is absent, but part of a recording medium surface not coated with ink remains as a streak in the moving direction of a recording head. The term “harshness” or “defective filling-in” means that local unevenness in the color density of related colors in printing of an area is absent, as described above, but part of a recording medium surface not coated with ink remains and exhibits graininess.

The reason that the addition of a water-soluble 1,3-alkane diol or alkylene glycol optionally having a branched chain, together with a poorly water-soluble alkane diol and a water-soluble 1,2-alkane diol optionally having a branched chain, as an essential component can form a high-quality image free from white streaks and harshness, as described above, is not clear, but is assumed as described below.

The aggregation of ink in recording on actual printing paper occurs probably because ink dots have a high surface tension, have a large contact angle with respect to the surface of the actual printing paper, and are therefore repelled by the actual printing paper. Even when white streaks or defective filling-in occurs in low-resolution recording, a decrease in the surface tension of ink adhering to the surface of actual printing paper reduces the aggregation of ink.

White streaks or defective filling-in in low-resolution recording occurs probably because ink dots adhering to the surface of actual printing paper come into contact with adjacent ink dots and spread over the surface, causing interactive flows of wet inks. These interactive ink flows probably result from the difference in the drying time of ink dots, which depends on the difference in the adhering time of adjacent ink dots and on the size of adhering droplets. Thus, to reduce the aggregation of ink and form high-quality images free from white streaks and harshness even in low-resolution printing, ink adhering to actual printing paper preferably has low surface tension and low flowability.

However, the absence of a penetrating lubricant to reduce the flowability of ink may accelerate the drying of ink dots adhering to the surface of actual printing paper and the absorption of ink to reduce the duration of time during which the adhering ink dots spread over the surface, thereby causing white streaks or defective filling-in in low-resolution recording.

The water-soluble 1,3-alkane diol optionally having a branched chain for use in the invention is a viscous substance like glycerin. The water-soluble 1,3-alkane diol is a penetrating lubricant that has a lower surface tension than glycerin. For example, a 10% aqueous solution of 1,3-butanediol has a surface tension of 55 mN/m, and a 10% aqueous solution of 3-methyl-1,3-butanediol has a surface tension of 53 mN/m. The alkylene glycol for use in the invention is a viscous substance like glycerin. The alkylene glycol is a penetrating lubricant that has a lower surface tension than glycerin. For example, a 10% aqueous solution of dipropylene glycol has a surface tension of 55 mN/m.

Furthermore, as an alcohol solvent, a combination of a poorly water-soluble alkane diol, a water-soluble 1,2-alkane diol optionally having a branched chain, and a water-soluble 1,3-alkane diol or alkylene glycol optionally having a branched chain has better ink drying characteristics than a combination of a poorly water-soluble alkane diol, a water-soluble alkane diol, and an alkane triol. It therefore seems that high-quality images can be formed on not only a low-liquid-absorbing recording medium, such as actual printing paper, but also non-liquid-absorbing recording medium, such as a resin film.

In the invention, the poorly water-soluble alkane diol is preferably an alkane diol having 7 to 10 carbon atoms, for example, 1,2-heptanediol, 1,2-octanediol, 5-methyl-1,2-hexanediol, 4-methyl-1,2-hexanediol, or 4,4-dimethyl-1,2-pentanediol. Among others, 1,2-octanediol is more preferred.

The water-soluble 1,2-alkane diol optionally having a branched chain is preferably an alkane diol having not more than 6 carbon atoms, for example, 1,2-hexanediol, 1,2-pentanediol, 1,2-butanediol, 4-methyl-1,2-pentanediol, or 3,3-dimethyl-1,2-butanediol. Among others, a water-soluble alkane diol a 15% aqueous solution of which has a surface tension of 28 mN/m or less is more preferred, and 1,2-hexanediol (surface tension: 26.7 mN/m), 4-methyl-1,2-pentanediol (surface tension: 25.4 mN/m), and 3,3-dimethyl-1,2-butanediol (surface tension: 26.1 mN/m) are particularly preferred. In terms of offensive smell in printing, 1,2-hexanediol is more preferred.

The water-soluble 1,3-alkane diol optionally having a branched chain is preferably an alkane diol having a main chain containing 4 to 7 carbon atoms, for example, 1,3-butanediol or 3-methyl-1,3-butanediol.

The alkylene glycol is preferably, but not limited to, an alkylene glycol having 2 to 9 carbon atoms and is more preferably diethylene glycol, dipropylene glycol, triethylene glycol, or tripropylene glycol. Among others, dipropylene glycol having a main chain containing 6 carbon atoms is more preferred in terms of dissolution of clogging.

In the three alcohol solvents described above, the ratio of the amount of poorly water-soluble alkane diol to the amount of water-soluble 1,2-alkane diol optionally having a branched chain preferably ranges from 6:1 to 1:3, more preferably 6:1 to 1:1. In these ranges, the poorly water-soluble alkane diol can be stably dissolved in ink, and the ejection stability improves. When the proportion of water-soluble 1,2-alkane diol is in these ranges, the initial viscosity of ink and uneven aggregation can be easily decreased simultaneously. Furthermore, when the proportion of water-soluble 1,2-alkane diol is in these ranges, a poorly water-soluble alcohol solvent can be easily and stably dissolved in ink, chronological changes in the viscosity of ink is prevented, and the storage stability of ink is easily maintained.

The ratio of the amount of poorly water-soluble alkane diol to the amount of water-soluble 1,3-alkane diol optionally having a branched chain preferably ranges from 1:1 to 1:18, more preferably 1:1 to 1:6, still more preferably 1:1 to 1:3. In these ranges, the initial viscosity of ink can be decreased, and high dissolution of clogging can be achieved. When the proportion of water-soluble 1,3-alkane diol is in these ranges, the initial viscosity of ink can be decreased, and a deterioration in drying characteristics can be prevented. Furthermore, when the proportion of water-soluble 1,3-alkane diol is in these ranges, high dissolution of clogging can be achieved, and a deterioration in drying characteristics can be prevented to ensure the duration of time during which ink spreads over. Thus, a recording medium can be coated with ink, and white streaks rarely occur.

The ratio of the amount of poorly water-soluble alkane diol to the amount of alkylene glycol preferably ranges from 1:1 to 1:18, more preferably 1:1 to 1:6, still more preferably 1:1 to 1:3. In these ranges, the initial viscosity of ink can be decreased, and high dissolution of clogging can be achieved. When the proportion of alkylene glycol is in these ranges, the initial viscosity of ink can be decreased, and a deterioration in drying characteristics can be prevented. Furthermore, when the proportion of alkylene glycol is in these ranges, high dissolution of clogging can be achieved, and a deterioration in drying characteristics can be prevented to ensure the duration of time during which ink spreads over. Thus, a recording medium can be coated with ink, and white streaks rarely occur.

The ratio of the amount of water-soluble 1,2-alkane diol optionally having a branched chain to the amount of water-soluble 1,3-alkane diol optionally having a branched chain preferably ranges from 1:1 to 1:36, more preferably 1:1 to 1:18. In these ranges, in low-resolution printing on actual printing paper, the occurrence of white streaks and harshness can be reduced. When the proportion of water-soluble 1,2-alkane diol is in these ranges, the initial viscosity of ink can be decreased, and a deterioration in drying characteristics can be prevented. Furthermore, when the proportion of water-soluble 1,3-alkane diol is in these ranges, high dissolution of clogging can be achieved, and a deterioration in drying characteristics can be prevented to ensure the duration of time during which ink spreads over. Thus, a recording medium can be coated with ink, and white streaks rarely occur.

The ratio of the amount of water-soluble 1,2-alkane diol optionally having a branched chain to the amount of alkylene glycol preferably ranges from 1:1 to 1:36, more preferably 1:1 to 1:18. In these ranges, in low-resolution printing on actual printing paper, the occurrence of white streaks and harshness can be reduced. When the proportion of water-soluble 1,2-alkane diol is in these ranges, the initial viscosity of ink can be decreased, and a deterioration in drying characteristics can be prevented. Furthermore, when the proportion of alkylene glycol is in these ranges, high dissolution of clogging can be achieved, and a deterioration in drying characteristics can be prevented to ensure the duration of time during which ink spreads over. Thus, a recording medium can be coated with ink, and white streaks rarely occur.

In the invention, the total amount of poorly water-soluble alkane diol and water-soluble 1,2-alkane diol optionally having a branched chain is preferably 6% by weight or less of the amount of ink composition. In this range, in a recording medium having low ink absorbency, such as actual printing paper, uneven aggregation does not occur, and the ejection stability is also excellent.

In the invention, the total amount of poorly water-soluble alkane diol and water-soluble 1,3-alkane diol optionally having a branched chain is preferably 21% by weight or less of the amount of ink composition. In this range, in a recording medium having low ink absorbency, such as actual printing paper, uneven aggregation does not occur, and the ejection stability is also excellent.

In the invention, the total amount of poorly water-soluble alkane diol and alkylene glycol is preferably 21% by weight or less of the amount of ink composition. In this range, in a recording medium having low ink absorbency, such as actual printing paper, uneven aggregation does not occur, and the ejection stability is also excellent.

The amount of poorly water-soluble alkane diol preferably ranges from 1% to 3% by weight, more preferably 1.5% to 2.5% by weight, of the total amount of ink composition. At an amount of poorly water-soluble alkane diol in the range of 1% to 3% by weight, in a recording medium having low ink absorbency, such as actual printing paper, uneven printing rarely occurs, and incomplete dissolution of the poorly water-soluble alkane diol in ink also rarely occurs.

The amount of water-soluble 1,2-alkane diol optionally having a branched chain preferably ranges from 0.5% to 6% by weight, more preferably 0.5% to 3.0% by weight. At an amount of water-soluble 1,2-alkane diol in the range of 0.5% to 6% by weight, a poorly water-soluble alkane diol can be dissolved in ink, and the initial viscosity of ink can be decreased.

The amount of water-soluble 1,3-alkane diol optionally having a branched chain preferably ranges from 3% to 18% by weight, more preferably 5% to 8% by weight, of the total amount of ink composition. At an amount of water-soluble 1,3-alkane diol in the range of 3% to 18% by weight, in low-resolution printing on actual printing paper, white streaks or harshness rarely occurs, and a deterioration in the drying characteristics of printed matter immediately after printing also rarely occurs.

The amount of alkylene glycol preferably ranges from 3% to 18% by weight, more preferably 5% to 8% by weight, of the total amount of ink composition. At an amount of alkylene glycol in the range of 3% to 18% by weight, in low-resolution printing on actual printing paper, white streaks or harshness rarely occurs, and a deterioration in the drying characteristics of printed matter immediately after printing also rarely occurs.

An ink composition according to the invention contains a surfactant as an essential component. Use of a surfactant for a recording medium coated with a resin for receiving ink allows excellent glossy images to be formed even on recording media in which the gloss is more important, such as photographic paper. Among others, like actual printing paper, even in recording media that include a surface receptor layer having a coated layer for receiving an oil-based ink, blurring (bleeding) between colors can be prevented, and whitening due to reflected light generated with an increase in the amount of adhered ink can be prevented.

An organopolysiloxane surfactant can be suitably used as a surfactant for use in the invention and increase the wettability of ink on the surface of a recording medium in the formation of an image to be recorded, thus improving ink penetration. When an organopolysiloxane surfactant is used, the three alcohol solvents described above improve the solubility of the surfactant in ink, thus reducing the occurrence of insoluble matter. An ink composition having improved ejection stability can therefore be provided.

The surfactant described above may be a commercially available surfactant, such as Olfin PD-501 (manufactured by Nissin Chemical Industry Co., Ltd.), Olfin PD-502 (manufactured by Nissin Chemical Industry Co., Ltd.), or Olfin PD-570 (manufactured by Nissin Chemical Industry Co., Ltd.).

More preferably, the organopolysiloxane surfactant contains one or two or more compounds having the following formula (I):

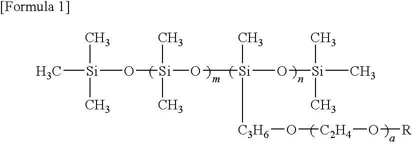

(wherein R denotes a hydrogen atom or a methyl group, a denotes an integer in the range of 2 to 11, m denotes an integer in the range of 2 to 50, and n denotes an integer in the range of 1 to 5.) or contains one or two or more compounds having the formula (I) in which R denotes a hydrogen atom or a methyl group, a denotes an integer in the range of 2 to 13, m denotes an integer in the range of 2 to 50, and n denotes an integer in the range of 1 to 5. More preferably, the organopolysiloxane surfactant contains one or two or more compounds having the formula (I) in which R denotes a hydrogen atom or a methyl group, a denotes an integer in the range of 2 to 13, m denotes an integer in the range of 2 to 50, and n denotes an integer in the range of 1 to 8. More preferably, the organopolysiloxane surfactant contains one or two or more compounds having the formula (I) in which R denotes a methyl group, a denotes an integer in the range of 6 to 18, m is 0, and n is 1. Use of such a particular organopolysiloxane surfactant further improves the uneven aggregation of ink even in printing on a recording medium of actual printing paper.

Among the compounds having the formula (I), a compound in which a denotes an integer in the range of 2 to 5, m denotes an integer in the range of 20 to 40, and n denotes an integer in the range of 2 to 4, a compound in which a denotes an integer in the range of 7 to 11, m denotes an integer in the range of 30 to 50, and n denotes an integer in the range of 3 to 5, a compound in which a denotes an integer in the range of 9 to 13, m denotes an integer in the range of 2 to 4, and n denotes an integer of 1 or 2, or a compound in which a denotes an integer in the range of 6 to 10, m denotes an integer in the range of 10 to 20, and n denotes an integer in the range of 4 to 8 is more preferably used. Use of such compounds can further improve the uneven aggregation of ink.

Still more preferably, a compound having the formula (I) in which R denotes a hydrogen atom, a denotes an integer in the range of 2 to 5, m denotes an integer in the range of 20 to 40, and n denotes an integer in the range of 2 to 4 or a compound having the formula (I) in which a denotes an integer in the range of 7 to 11, m denotes an integer in the range of 30 to 50, and n denotes an integer in the range of to 5 is used. Use of such compounds can further improve the uneven aggregation and blurring of ink.

Still more preferably, a compound having the formula (I) in which R denotes a methyl group, a denotes an integer in the range of 9 to 13, m denotes an integer in the range of 2 to 4, and n denotes an integer of 1 or 2 or a compound having the formula (I) in which a denotes an integer in the range of 6 to 10, m denotes an integer in the range of 10 to 20, and n denotes an integer in the range of 4 to 8 is used. Use of such compounds can further improve the uneven aggregation and blurring of ink.

Still more preferably, a compound having the formula (I) in which R denotes a methyl group, a denotes an integer in the range of 6 to 12, m is 0, and n is 1 is used. Use of such compounds can further improve the uneven aggregation and blurring of ink.

Most preferably, a mixture of a compound having the formula (I) in which R denotes a hydrogen atom, a denotes an integer in the range of 7 to 11, m denotes an integer in the range of 30 to 50, and n denotes an integer in the range of 3 to 5, a compound having the formula (I) in which R denotes a methyl group, a denotes an integer in the range of 9 to 13, m denotes an integer in the range of 2 to 4, and n denotes an integer of 1 or 2, and a compound having the formula (I) in which R denotes a methyl group, a denotes an integer in the range of 6 to 10, m denotes an integer in the range of 10 to 20, and n denotes an integer in the range of 4 to 8 is used. Use of such compounds can further improve the uneven aggregation and blurring of ink.

Most preferably, a mixture of a compound having the formula (I) in which R denotes a hydrogen atom, a denotes an integer in the range of 7 to 11, m denotes an integer in the range of 30 to 50, and n denotes an integer in the range of 3 to 5, a compound having the formula (I) in which R denotes a methyl group, a denotes an integer in the range of 9 to 13, m denotes an integer in the range of 2 to 4, and n denotes an integer of 1 or 2, and a compound having the formula (I) in which R denotes a methyl group, a denotes an integer in the range of 6 to 18, m is 0, and n is 1 is used. Use of such compounds can further improve the uneven aggregation and blurring of ink.

An ink composition according to the invention preferably contains 0.01% to 1.0% by weight, more preferably 0.05% to 0.50% by weight, of the surfactant. A combined use of a surfactant in which R denotes a methyl group and a surfactant in which R denotes a hydrogen atom is more preferred because letters in a small font are not damaged. In particular, in terms of the uneven aggregation of ink, the amount of surfactant in which R denotes a methyl group is preferably greater than the amount of surfactant in which R denotes H.

A greater amount of surfactant in which R denotes H than the amount of surfactant in which R denotes a methyl group is more preferred. This can improve the uneven aggregation and blurring of ink even in actual printing paper that has a tendency to repel ink and has a low penetration speed, such as cast-coated paper.

Another surfactant, more specifically, an acetylene glycol surfactant, an anionic surfactant, a nonionic surfactant, or an amphoteric surfactant may be added to an ink composition according to the invention.

Examples of the acetylene glycol surfactant include 2,4,7,9-tetramethyl-5-decyne-4,7-diol, 3,6-dimethyl-4-octyne-3,6-diol, 3,5-dimethyl-1-hexyne-3ol, and 2,4-dimethyl-5-hexyne-3-ol. The acetylene glycol surfactant may also be a commercial product, for example, Olfin E1010, STG, or Y (trade name, manufactured by Nissin Chemical Industry Co., Ltd.), or Surfynol 61, 104, 82, 465, 485, or TG (trade name, manufactured by Air Products and Chemicals Inc.).

An ink composition according to the invention contains an oxyethyl acrylate resin as a dispersant for dispersing pigment. The presence of an oxyethyl acrylate resin as a dispersant for dispersing pigment can achieve high dissolution of clogging and high-temperature storage stability. Furthermore, use of a combination of an oxyethyl acrylate resin and a solid solution of C.I. Pigment Red 202 and γ-type C.I. Pigment Violet 19 and/or γ-type C.I. Pigment Violet 19 can achieve high dissolution of clogging and high-temperature storage stability.

The oxyethyl acrylate resin is preferably, but not limited to, a compound having the following formula (II). For example, the compound having the following formula (II) is a resin that contains, on the basis of monomer molar ratio, 45% to 55% ortho-hydroxyethylated phenylphenol acrylate (CAS No. 72009-86-0), 20% to 30% acrylic acid (CAS No. 79-10-7), and 20% to 30% methacrylic acid (CAS No. 79-41-4). These may be used alone or in combination. The monomer composition is preferably, but not limited to, 70% to 85% ortho-hydroxyethylated phenylphenol acrylate (CAS No. 72009-86-0), 5% to 15% acrylic acid (CAS No. 79-10-7), and 10% to 20% methacrylic acid (CAS No. 79-41-4).

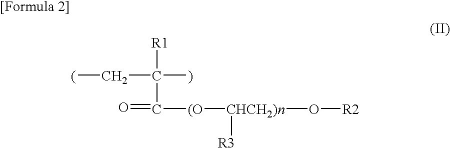

(wherein R1 and/or R3 denotes a hydrogen atom or a methyl group, R2 denotes an alkyl group or an aryl group, and n is an integer of 1 or more.)

Preferably, the compound having the formula (II) is nonylphenoxypolyethylene glycol acrylate or polypropylene glycol #700 acrylate.

The amount of oxyethyl acrylate resin preferably ranges from 1.0% to 6.0% by weight to satisfy both the initial viscosity of an ink composition and the storage stability of the ink composition, reduce uneven aggregation, and form color images with excellent filling-in.

The total percentage of resins derived from a monomer having a hydroxy group selected from the group consisting of acrylic acid and methacrylic acid in the oxyethyl acrylate resin preferably ranges from 30% to 70%, more preferably 40% to 60%, to satisfy both the initial viscosity of an ink composition and the storage stability of the ink composition and in terms of the dissolution of clogging.

The weight-average molecular weight (Mw) of the oxyethyl acrylate resin before crosslinking preferably ranges from 30,000 to 100,000, more preferably 50,000 to 80,000, to satisfy both the initial viscosity of an ink composition and the storage stability of the ink composition. For example, Mw is measured with gel permeation chromatography (GPC).

The oxyethyl acrylate resin may be adsorbed on or separated from pigment in pigment dispersion. The maximum particle size of the copolymer resin is preferably 0.3 μm or less, and the average particle size is more preferably 0.2 μm or less (still more preferably 0.1 μm or less) to satisfy the gloss of color images, bronzing prevention, and the storage stability of an ink composition and to form glossier color images. The average particle size is the average of the diameter of actually dispersed pigment particles (cumulative 50% diameter) in dispersion and can be measured, for example, with Microtrac UPA (Microtrac Inc.).

An ink composition according to the invention may contain, as a dispersant for dispersing pigment, at least one resin selected from the group consisting of a styrene-acrylic acid copolymer resin, which is a copolymer resin of a hydrophobic monomer and a hydrophilic monomer, a urethane resin, and a fluorene resin. These copolymer resins adsorb to pigment and thereby improve pigment dispersion.

Specific examples of a hydrophobic monomer for use in the copolymer resins include methyl acrylate, methyl methacrylate, ethyl acrylate, ethyl methacrylate, n-propyl acrylate, n-propyl methacrylate, iso-propyl acrylate, iso-propyl methacrylate, n-butyl acrylate, n-butyl methacrylate, sec-butyl acrylate, sec-butyl methacrylate, tert-butyl acrylate, tert-butyl methacrylate, n-hexyl acrylate, n-hexyl methacrylate, n-octyl acrylate, n-octyl methacrylate, iso-octyl acrylate, iso-octyl methacrylate, 2-ethylhexyl acrylate, 2-ethylhexyl methacrylate, decyl acrylate, decyl methacrylate, lauryl acrylate, lauryl methacrylate, stearyl acrylate, stearyl methacrylate, 2-hydroxyethyl acrylate, 2-hydroxyethyl methacrylate, 2-hydroxypropyl acrylate, 2-hydroxypropyl methacrylate, 2-dimethylaminoethyl acrylate, 2-dimethylaminoethyl methacrylate, 2-diethylaminoethyl acrylate, 2-dimethylaminoethyl methacrylate, glycidyl acrylate, glycidyl methacrylate, allyl acrylate, allyl methacrylate, cyclohexyl acrylate, cyclohexyl methacrylate, phenyl acrylate, phenyl methacrylate, nonylphenyl acrylate, nonylphenyl methacrylate, benzyl acrylate, benzyl methacrylate, dicyclopentenyl acrylate, dicyclopentenyl methacrylate, bornyl acrylate, bornyl methacrylate, 1,3-butanediol diacrylate, 1,3-butanediol dimethacrylate, 1,4-butanediol diacrylate, 1,4-butanediol dimethacrylate, ethylene glycol diacrylate, ethylene glycol dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, polyethylene glycol diacrylate, polyethylene glycol dimethacrylate, neopentyl glycol diacrylate, 1,6-hexanediol diacrylate, 1,6-hexanediol dimethacrylate, dipropylene glycol diacrylate, dipropylene glycol dimethacrylate, trimethylolpropane triacrylate, trimethylolpropane trimethacrylate, glycerol acrylate, glycerol methacrylate, styrene, methylstyrene, and vinyltoluene. These may be used alone or in combination.

Specific examples of a hydrophilic monomer include acrylic acid, methacrylic acid, maleic acid, and itaconic acid.

Preferably, the copolymer resin between a hydrophobic monomer and a hydrophilic monomer is at least one selected from the group consisting of a styrene-(meth)acrylic acid copolymer resin, a styrene-methylstyrene-(meth)acrylic acid copolymer resin, a styrene-maleic acid copolymer resin, a (meth)acrylic acid-(meth)acrylate copolymer resin, and a styrene-(meth)acrylic acid-(meth)acrylate copolymer resin to satisfy the gloss of color images, bronzing prevention, and the storage stability of an ink composition and to form glossier color images.

The copolymer resin may be a resin that contains a polymer produced by the reaction between styrene and acrylic acid or acrylate (styrene-acrylic acid resin). Alternatively, the copolymer resin may be a water-soluble acrylic acid resin. Alternatively, the copolymer resin may be a sodium, potassium, or ammonium salt of the water-soluble acrylic acid resin.

The amount of copolymer resin preferably ranges from 10 to 50 parts by weight, more preferably 10 to 35 parts by weight, per 100 parts by weight of the pigment to satisfy the gloss of color images, bronzing prevention, and the storage stability of an ink composition and to form glossier color images.

In the invention, a urethane resin can be used as a pigment dispersant to satisfy the gloss of color images, bronzing prevention, and the storage stability of an ink composition and form glossier color images. While a urethane resin is a resin that contains a polymer produced by the reaction between a diisocyanate compound and a diol compound, the urethane resin is preferably a resin that has a urethane bond and/or an amide bond and an acidic group in the invention.

Examples of the diisocyanate compound include araliphatic diisocyanate compounds, such as hexamethylene diisocyanate and 2,2,4-trimethylhexamethylene diisocyanate, aromatic diisocyanate compounds, such as tolylene diisocyanate and phenylmethane diisocyanate, and modified compounds thereof.

Examples of the diol compound include polyethers, such as polyethylene glycol and polypropylene glycol, polyesters, such as poly(ethylene adipate) and poly(butylene adipate), and polycarbonates.

Preferably, the urethane resin has a carboxyl group.

In the invention, a fluorene resin may also be used as a pigment dispersant.

The weight ratio (the former/the latter) of the copolymer resin to the urethane resin preferably ranges from 1/2 to 2/1 and, to satisfy the gloss of color images, bronzing prevention, and the storage stability of an ink composition and to form glossier color images, more preferably ranges from 1/1.5 to 1.5/1.

The weight ratio (the former/the latter) of the pigment solid content to the solid content other than the pigment preferably ranges from 100/20 to 100/80 to satisfy the gloss of color images, bronzing prevention, and the storage stability of an ink composition and to form glossier color images.

The amount of copolymer resin preferably ranges from 10 to 50 parts by weight, more preferably 10 to 35 parts by weight, per 100 parts by weight of the pigment to satisfy the gloss of color images, bronzing prevention, and the storage stability of an ink composition and to form glossier color images.

The amount of urethane resin preferably ranges from 10 to 40 parts by weight, more preferably 10 to 35 parts by weight, per 100 parts by weight of the pigment to satisfy the gloss of color images, bronzing prevention, and the storage stability of an ink composition and to form glossier color images.

The amount of fluorene resin preferably ranges from 20 to 200 parts by weight, more preferably 10 to 80 parts by weight, per 100 parts by weight of the pigment to satisfy the gloss of color images, bronzing prevention, and the storage stability of an ink composition and to form glossier color images.

The total amount of copolymer resin and urethane resin is preferably 90 parts by weight or less (more preferably 70 parts by weight or less) per 100 parts by weight of the pigment to satisfy the gloss of color images, bronzing prevention, and the storage stability of an ink composition and to form glossier color images.

The acid value of the copolymer resin preferably ranges from 50 to 320, more preferably 100 to 250, to satisfy the gloss of color images, bronzing prevention, and the storage stability of an ink composition and to form glossier color images.

The acid value of the urethane resin preferably ranges from 10 to 300, more preferably 20 to 100, to satisfy the gloss of color images, bronzing prevention, and the storage stability of an ink composition and to form glossier color images. The acid value is the amount of KOH (mg) required to neutralize 1 g of resin.

The weight-average molecular weight (Mw) of the copolymer resin preferably ranges from 2,000 to 30,000, more preferably 2,000 to 20,000, to satisfy the gloss of color images, bronzing prevention, and the storage stability of an ink composition and to form glossier color images.

The weight-average molecular weight (Mw) of the urethane resin before crosslinking preferably ranges from 100 to 200,000, more preferably 1,000 to 50,000, to satisfy the gloss of color images, bronzing prevention, and the storage stability of an ink composition and to form glossier color images. For example, Mw is measured with gel permeation chromatography (GPC).

The glass transition temperature (Tg, as determined by JIS K 6900) of the copolymer resin is preferably at least 30° C. and more preferably ranges from 50° C. to 130° C. to satisfy the gloss of color images, bronzing prevention, and the storage stability of an ink composition and to form glossier color images.

The glass transition temperature (Tg, as determined by JIS K 6900) of the urethane resin preferably ranges from −50° C. to 200° C., more preferably −50° C. to 100° C., to satisfy the gloss of color images, bronzing prevention, and the storage stability of an ink composition and to form glossier color images.

The copolymer resin may be adsorbed on or separated from pigment in pigment dispersion. The maximum particle size of the copolymer resin is preferably 0.3 μm or less, and the average particle size is more preferably 0.2 μm or less (still more preferably 0.1 μm or less) to satisfy the gloss of color images, bronzing prevention, and the storage stability of an ink composition and to form glossier color images. The average particle size is the average of the diameter of actually dispersed pigment particles (cumulative 50% diameter) in dispersion and can be measured, for example, with Microtrac UPA (Microtrac Inc.).

The fluorene resin may be any resin having a fluorene skeleton and can be manufactured by copolymerization of monomer units described below.

Cyclohexane, 5-isocyanate-1-(isocyanatemethyl)-1,3,3-trimethyl (CAS No. 4098-71-9)

Ethanol, 2,2′-[9H-fluorene-9-ylidenebis(4,1-phenyleneoxy)]bis (CAS No. 117344-32-8)

Propionic acid, 3-hydroxy-2-(hydroxymethyl)-2-methyl (CAS No. 4767-03-7)

Ethanamine, N,N-diethyl- (CAS No. 121-44-8)

A surfactant may be contained as the dispersant. Examples of the surfactant include anionic surfactants, such as fatty acid salts, higher alkyl dicarboxylates, higher alcohol sulfuric acid ester salts, higher alkyl sulfonates, condensates of higher fatty acids and amino acids, sulfosuccinic acid ester salts, naphthenates, liquid fatty oil sulfuric acid ester salts, and alkylallyl sulfonates; cationic surfactants, such as fatty acid amine salts, quaternary ammonium salts, sulfonium salts, and phosphonium; and nonionic surfactants, such as polyoxyethylene alkyl ethers, polyoxyethylene alkyl esters, sorbitan alkyl esters, and polyoxyethylene sorbitan alkyl esters. It goes without saying that the surfactant added to an ink composition also functions as a surfactant.

An ink composition for use in the invention contains the alkane diol and the surfactant described above, other various additive agents, and water as a solvent. Preferably, water is pure or ultrapure water, such as ion-exchanged water, ultrafiltered water, reverse osmosis water, or distilled water. In particular, water sterilized, for example, by ultraviolet irradiation or the addition of hydrogen peroxide is free from mold or bacterium for a long period of time and is therefore preferred.

In the invention, an ink composition contains a penetrant, in addition to the components described above.

Glycol ethers are suitably used as penetrants.

Specific examples of glycol ethers include ethylene glycol monomethyl ether, ethylene glycol monoethyl ether, ethylene glycol mono-iso-propyl ether, ethylene glycol mono-n-butyl ether, ethylene glycol mono-iso-butyl ether, ethylene glycol mono-tert-butyl ether, ethylene glycol monomethyl ether acetate, diethylene glycol monomethyl ether, diethylene glycol monoethyl ether, diethylene glycol mono-n-propyl ether, diethylene glycol mono-iso-propyl ether, diethylene glycol mono-n-butyl ether, diethylene glycol mono-tert-butyl ether, triethylene glycol mono-n-butyl ether, propylene glycol monomethyl ether, propylene glycol monoethyl ether, propylene glycol mono-n-propyl ether, propylene glycol mono-iso-propyl ether, propylene glycol mono-n-butyl ether, propylene glycol mono-tert-butyl ether, dipropylene glycol monomethyl ether, dipropylene glycol monoethyl ether, dipropylene glycol mono-n-propyl ether, dipropylene glycol-iso-propyl ether, dipropylene glycol mono-n-butyl ether, dipropylene glycol mono-tert-butyl ether, and 1-methyl-1-methoxybutanol, which are used alone or as a mixture thereof.

Among the glycol ethers described above, alkyl ethers of polyhydric alcohols are preferred, and ethylene glycol monoethyl ether, ethylene glycol mono-n-butyl ether, diethylene glycol monomethyl ether, diethylene glycol monoethyl ether, diethylene glycol mono-n-butyl ether, propylene glycol monomethyl ether, propylene glycol monoethyl ether, propylene glycol monobutyl ether, triethylene glycol monomethyl ether, triethylene glycol monoethyl ether, and triethylene glycol mono-n-butyl ether are particularly preferred.

Triethylene glycol mono-n-butyl ether is more preferred.

The amount of the penetrant may be determined appropriately and preferably ranges from approximately 0.1% to 30% by weight, more preferably approximately 1% to 20% by weight.

Preferably, in addition to the components described above, an ink composition contains a recording medium solubilizer.

Pyrrolidones, such as N-methyl-2-pyrrolidone, are suitably used as the recording medium solubilizer. The amount of recording medium solubilizer may be determined appropriately and preferably ranges from approximately 0.1% to 30% by weight, more preferably approximately 1% to 20% by weight.

Preferably, an ink composition used in the invention is substantially free from a wetting agent. Since a wetting agent prevents ink from being dried and solidified, for example, in an ink jet nozzle, ink dropped on synthetic paper having particularly low ink absorbency may remain wet. This may cause a problem in high-speed printing. When an ink containing a wetting agent is used, while unabsorbed ink remains on the recording medium surface, the subsequent ink adheres to the recording medium. This may cause uneven aggregation.

Thus, in the invention, when such a recording medium having particularly low ink absorbency is used, preferably, the ink composition is substantially free from a wetting agent. Even when ink is solidified in an ink jet nozzle, a solution containing a wetting agent may be used to redissolve the solidified ink.

In particular, in the invention, preferably, the ink composition is substantially free from a wetting agent having a vapor pressure of 2 mPa or less at 25° C. The phrase “substantially free from” means that the amount of wetting agent is less than 1% by weight of the amount of ink composition.

When the amount of a wetting agent having a vapor pressure of 2 mPa or less at 25° C. is less than 1% by weight of the amount of ink, not only recording media having low ink absorbency, such as actual printing paper, but also metals or plastics, which do not absorb ink, can be printed by an ink jet recording method. Although it is apparent to a person skilled in the art that part of the penetrating solvents described above also act as wetting agents, the penetrating solvents are not included in the wetting agent in the present specification. In the present specification, the alkane diol described above is not included in the wetting agent.

The term “wetting agent”, as used herein, refers to a wetting agent for use in general ink compositions. An ink composition used in the invention may contain an alcohol other than the alcohol solvent described above. More specifically, the alcohol may be trimethylolpropane, trimethylolmethane, or trimethylolethane. When a recording medium is actual printing paper having low ink absorbency, the wetting agent can be appropriately added.

An ink composition used in the invention may further contain an agent to prevent nozzle clogging, a preservative, an antioxidant, an electric conductivity modifier, a pH-adjusting agent, a viscosity modifier, a surface tension modifier, and an oxygen absorbent.

Examples of the preservative and fungicide include sodium benzoate, pentachlorophenol sodium, 2-pyridinethiol-1-oxide sodium, sodium sorbate, sodium dehydroacetate, and 1,2-dibenzinethiazoline-3-one (Proxel CRL, Proxel BND, Proxel GXL, Proxel XL-2, and Proxel TN manufactured by ICI).

Examples of the pH adjusting agent, dissolution aid, or antioxidant include amines, such as diethanolamine, triethanolamine, propanolamine, and morpholine, modified compounds thereof, inorganic salts, such as potassium hydroxide, sodium hydroxide, and lithium hydroxide, ammonium hydroxide, quaternary ammonium hydroxide (tetramethylammonium etc.), carbonates, such as potassium carbonate, sodium carbonate, and lithium carbonate, phosphates, N-methyl-2-pyrrolidone, ureas, such as urea, thiourea, and tetramethylurea, allophanates, such as allophanate and methyl allophanate, biurets, such as biuret, dimethylbiuret, and tetramethylbiuret, and L-ascorbic acid and its salts.

An ink composition used in the invention may contain an antioxidant and an ultraviolet absorber. Examples of the antioxidant and the ultraviolet absorber include Tinuvin 328, 900, 1130, 384, 292, 123, 144, 622, 770, and 292, Irgacor 252 153, and Irganox 1010, 1076, 1035, and MD1024, manufactured by Chiba Specialty Chemicals Co., Ltd., and lanthanide oxides.

An ink composition used in the invention can be manufactured by dispersing and mixing the components described above by an appropriate method. Preferably, first, a pigment, a polymer dispersant, and water are mixed in an appropriate dispersing apparatus (for example, a ball mill, a sand mill, an attritor, a rolling mill, an agitator mill, a Henschel mixer, a colloid mill, an ultrasonic homogenizer, a jet mill, or Angmill (trade name)) to prepare homogeneous pigment dispersion, and a resin (resin emulsion) prepared separately, water, a water-soluble organic solvent, a sugar, a pH preparation agent, a preservative, and a fungicide are then sufficiently dissolved in the dispersion to prepare an ink solution. After being stirred sufficiently, the ink solution is filtered to remove coarse particle sizes and foreign substances responsible for clogging, thus yielding an intended ink composition.

### Ink Jet Recording Method

In an ink jet recording method according to the invention, droplets of the ink composition described above are discharged to adhere to a recording medium for printing. In a recording method according to the invention, synthetic paper or actual printing paper mainly composed of synthetic resin is preferably used as a recording medium. In particular, even in low-resolution printing on art paper, high-quality paper for print-on-demand (POD) applications, and special paper for laser printers, high-quality images free from white streaks and harshness can be formed. Examples of actual printing paper, such as art paper, include OK Top Coat Plus (manufactured by Oji Paper Co., Ltd.). Examples of high quality paper for POD applications that has the feel and texture of actual printing paper to which the suitability for ink jet is imparted include Ricoh business coat gloss 100 (manufactured by Ricoh Company, Ltd.). Examples of special paper for laser printers include LPCCTA4 (manufactured by Seiko Epson Co.). The absorption rate ability of ink in actual printing paper, paper for POD applications, and laser printer paper decreases in this order.

According to another aspect of the invention, an ink cartridge housing the ink composition described above is provided.

### Examples

The invention will be described in detail in the following examples. However, these examples do not limit the invention.

### Example 1

A magenta ink composition having the following composition was prepared. A styrene-acrylic acid resin in the composition is a copolymer having a molecular weight of 1600 and an acid value of 150. An oxyethyl acrylate resin is a resin that contains approximately 75% by weight of a monomer having an oxyethyl acrylate structure represented by CAS No. 72009-86-0 and that has a molecular weight of 6900. A surfactant used is an organopolysiloxane surfactant and is a mixed surfactant of a compound having the formula (I) in which R denotes a methyl group, a denotes an integer in the range of 9 to 13, m denotes an integer in the range of 2 to 4, and n denotes an integer of 1 or 2, a compound having the formula (I) in which R denotes a hydrogen atom, a denotes an integer in the range of 7 to 11, m denotes an integer in the range of 30 to 50, and n denotes an integer in the range of 3 to 5, and a compound having the formula (I) in which R denotes a methyl group, a denotes an integer in the range of 6 to 18, m is 0, and n is 1.

### <Magenta Ink Composition 1>

| | |
|---|---|
| Glycerin | 5.0% by weight |
| 1,2-hexanediol | 0.5% by weight |
| 1,2-octanediol | 3.0% by weight |
| 3-methyl-1,3-butanediol | 8.0% by weight |
| Surfactant | 0.1% by weight |
| Oxyethyl acrylate resin | 2.4% by weight |
| Fluorene resin | 2.4% by weight |
| Solid solution of C.I. Pigment Red 202 | 8.0% by weight |
| and γ-type C.I. Pigment Violet 19 | |
| Pure water | balance |
| | 100.0% by weight in total |

### Example 2

A magenta ink composition 2 was prepared in the same manner as the magenta ink composition 1 except that the solid solution of C.I. Pigment Red 202 and γ-type C.I. Pigment Violet 19 in the magenta ink composition 1 was substituted by γ-type C.I. Pigment Violet 19.

### Example 3

A magenta ink composition 3 was prepared in the same manner as the magenta ink composition 1 except that 3-methyl-1,3-butanediol in the magenta ink composition 1 was substituted by dipropylene glycol.

### Example 4

A magenta ink composition 4 was prepared in the same manner as the magenta ink composition 2 except that 3-methyl-1,3-butanediol in the magenta ink composition 2 was substituted by dipropylene glycol.

### Comparative Example 1

A magenta ink composition 5 was prepared in the same manner as the magenta ink composition 1 except that the oxyethyl acrylate resin in the magenta ink composition 1 was substituted by a styrene-acrylic acid resin and that the solid solution of C.I. Pigment Red 202 and γ-type C.I. Pigment Violet 19 was substituted by γ-type C.I. Pigment Violet 19.

### Comparative Example 2

A magenta ink composition 6 was prepared in the same manner as the magenta ink composition 1 except that the oxyethyl acrylate resin in the magenta ink composition 1 was substituted by a styrene-acrylic acid resin.

### Comparative Example 3

A magenta ink composition 7 was prepared in the same manner as the magenta ink composition 5 except that 3-methyl-1,3-butanediol in the magenta ink composition 5 was substituted by dipropylene glycol.

### Comparative Example 4

A magenta ink composition 8 was prepared in the same manner as the magenta ink composition 6 except that 3-methyl-1,3-butanediol in the magenta ink composition 6 was substituted by dipropylene glycol.

### Evaluation of Initial Viscosity of Ink

The ink viscosities of the magenta ink compositions 1 to 4 prepared as described above was evaluated. The viscosity of ink was measured one hour after the preparation of the ink with an oscillation viscometer (MV100 manufactured by Yamaichi Electronics Co., Ltd.) and was evaluated on the basis of the following criteria. The measurement temperature was 20° C.

S: The viscosity is 4 mPa·s or less.

AA: The viscosity is more than 4 mPa·s but not more than mPas.

A: The viscosity is more than 5 mPa·s but not more than 6 mPas.

B: The viscosity is more than 6 mPa·s but not more than mPas.

C: The viscosity is more than 7 mPa·s but not more than mPas.

D: The viscosity is more than 8 mPa·s.

Table 1 shows the evaluation results.

### Evaluation of Chronological Viscosity of Ink

After the magenta ink compositions 1 to 4 prepared as described above were left stand in an environment at 70° C. for three days, the viscosity of the ink was measured as described above and was evaluated on the basis of the following criteria.

A: A variation from the initial viscosity is 0.5 mPa·s or less.

B: A variation from the initial viscosity is more than 0.5 mPa·s but not more than 1.0 mPa·s.

C: A variation from the initial viscosity is more than 1.0 mPa·s but not more than 2.0 mPa·s.

D: A variation from the initial viscosity is more than 2.0 mPa·s.

Table 1 shows the evaluation results.

### Evaluation of Uneven Aggregation of Ink and Filling-In

Each of the magenta ink compositions 1 to 4 was charged in a magenta ink chamber of an ink cartridge in an ink jet printer (PX-G920, manufactured by Seiko Epson Co.) and was ejected at 720 dpi in a main scanning (head driving) direction and 360 dpi in a sub scanning (recording medium transport) direction. The voltage of the printer was then controlled such that the dot size of an adhering droplet was approximately 7 ng. A 720×720 dpi solid image was printed on approximately 128 g/m² OKT+ (manufactured by Oji Paper Co., Ltd.) and LPCCT (Seiko Epson Co.) at a single operation of 720×360 dpi. Recording was performed bidirectionally and unidirectionally in a normal temperature and normal humidity environment. The amount of adhered ink was approximately 3.6 mg/inch square meters.

The resulting image was evaluated on the basis of the following criteria.

A: Uneven aggregation and white streaks resulting from defective filling-in were observed even in bidirectional printing.

B: No uneven aggregation but white streaks resulting from defective filling-in were observed even in bidirectional printing.

C: Uneven aggregation was observed in bidirectional printing, and no uneven aggregation but white streaks resulting from defective filling-in were observed in unidirectional printing.

D: Uneven aggregation and white streaks resulting from defective filling-in were observed in unidirectional printing.

Table 1 shows the results.

### Evaluation of Damage to Small Font

Each of the magenta ink compositions 1 to 4 was charged in a magenta ink chamber of an ink cartridge in an ink jet printer (PX-G920, manufactured by Seiko Epson Co.) and could be ejected at 720 dpi in a main scanning (head driving) direction and 360 dpi in a sub scanning (recording medium transport) direction. In a normal temperature and normal humidity environment, the voltage of the printer was then controlled such that the dot size of an adhering droplet was approximately 7 ng, and when a 720×720 dpi solid image was printed at a single operation of 720×360 dpi, the fee of adhered ink was approximately 3.6 mg/inch square meters. Under this condition, Chinese characters for “bara (rose)” were printed unidirectionally at font sizes of 8 and 12 on approximately 128 g/m² OKT+ (manufactured by Oji Paper Co., Ltd.).

The resulting letters were evaluated on the basis of the following criteria.

A: The Chinese characters for “bara” at a font size of 8 can be easily recognized.

B: Although the Chinese characters for “bara” at a font size of 12 can be easily recognized, the Chinese characters for “bara” at a font size of 8 cannot be easily recognized.

C: The Chinese characters for “bara” at a font size of cannot be easily recognized.

Table 1 shows the results.

### Evaluation of Dissolution of Clogging 1

The ink cartridge and the ink jet printer described above were used. After an ink replacement button was pushed, printer was unplugged. In this way, after a head cap was removed, the printer was left stand at 40° C. and 15% RH for three days. After that, all the nozzles were repeatedly cleaned until the initial discharge performance was reproduced. The ease with which clogging was dissolved was evaluated on the basis of the following criteria. The magenta ink compositions 1 to 8 described above were evaluated.

A: Clogging is dissolved after three times of cleaning.

B: Clogging is dissolved after six times of cleaning.

C: Clogging is dissolved after 12 times of cleaning.

D: Clogging is not dissolved even after 12 times of cleaning.

### Evaluation of Dissolution of Clogging 2

The ink cartridge and the ink jet printer described above were used. After an ink replacement button was pushed, printer was unplugged. In this way, after a head cap was removed, the printer was left stand at 40° C. and 15% RH for four days. After that, all the nozzles were repeatedly cleaned until the initial discharge performance was reproduced. The ease with which clogging was dissolved was evaluated on the basis of the following criteria. The magenta ink compositions 1 to 8 described above were evaluated.

A: Clogging is dissolved after three times of cleaning.

B: Clogging is dissolved after six times of cleaning.

C: Clogging is dissolved after 12 times of cleaning.

D: Clogging is not dissolved even after 12 times of cleaning.

TABLE 1

| | | | Evaluation of | | | |
|---|---|---|---|---|---|---|
| | | Evaluation of | uneven | Evaluation of | Evaluation of | Evaluation of |
| | Evaluation of | chronological | aggregation of | damage to | dissolution of | dissolution |
| Sample | initial viscosity | viscosity | ink and filling-in | font | clogging 1 | of clogging 2 |
| Magenta ink composition 1 | A | A | A | B | A | B |
| (Example 1) | | | | | | |
| Magenta ink composition 2 | A | A | A | B | A | B |
| (Example 2) | | | | | | |
| Magenta ink composition 3 | — | — | — | — | A | A |
| (Example 3) | | | | | | |
| Magenta ink composition 4 | — | — | — | — | A | A |
| (Example 4) | | | | | | |
| Magenta ink composition 5 | B | A | B | B | B | C |
| (Comparative Example 1) | | | | | | |
| Magenta ink composition 6 | C | C | B | B | C | C |
| (Comparative Example 2) | | | | | | |
| Magenta ink composition 7 | — | — | — | — | B | C |
| (Comparative Example 3) | | | | | | |
| Magenta ink composition 8 | — | — | — | — | C | C |
| (Comparative Example 4) | | | | | | |

1. An ink composition, comprising:
at least a pigment, water, an alcohol solvent, a dispersant, and a surfactant, wherein the alcohol solvent contains a poorly water-soluble alkane diol, a water-soluble 1,2-alkane diol optionally having a branched chain, and a water-soluble 1,3-alkane diol or alkylene glycol optionally having a branched chain, and
the dispersant contains an oxyethyl acrylate resin.

2. The ink composition according to claim 1, wherein the pigment is a solid solution of C.I. Pigment Red 202 and γ-type C.I. Pigment Violet 19 and/or γ-type C.I. Pigment Violet 19.

3. The ink composition according to claim 1, wherein the poorly water-soluble alkane diol is an alkane diol having 7 to 10 carbon atoms.

4. The ink composition according to claim 1, wherein the water-soluble 1,2-alkane diol optionally having a branched chain is an alkane diol having not more than 6 carbon atoms.

5. (canceled)

6. The ink composition according to claim 1, wherein the alkylene glycol is an alkylene glycol having 2 to 9 carbon atoms.

7. The ink composition according to claim 1, wherein the ratio of the amount of poorly water-soluble alkane diol to the amount of water-soluble 1,2-alkane diol optionally having a branched chain ranges from 6:1 to 1:3.

8. The ink composition according to claim 1, wherein the ratio of the amount of poorly water-soluble alkane diol to the amount of water-soluble 1,3-alkane diol or alkylene glycol optionally having a branched chain ranges from 1:1 to 1:18.

9. The ink composition according to claim 1, wherein the total amount of poorly water-soluble alkane diol and water-soluble 1,2-alkane diol optionally having a branched chain is 6% by weight or less of the amount of ink composition.

10. The ink composition according to claim 1, wherein the total amount of poorly water-soluble alkane diol and water-soluble 1,3-alkane diol or alkylene glycol optionally having a branched chain is 21% by weight or less of the amount of ink composition.

11. The ink composition according to claim 1, wherein the amount of poorly water-soluble alkane diol ranges from 1% to 3% by weight of the amount of ink composition.

12. The ink composition according to any claim 1, wherein the amount of water-soluble 1,2-alkane diol optionally having a branched chain ranges from 0.5% to 3.0% by weight of the amount of ink composition.

13. The ink composition according to claim 1, wherein the amount of water-soluble 1,3-alkane diol or alkylene glycol optionally having a branched chain ranges from 3% to 18% by weight of the amount of ink composition.

14. The ink composition according to claim 1, wherein the poorly water-soluble alkane diol is 1,2-octanediol.

15. The ink composition according to claim 1, wherein the water-soluble 1,2-alkane diol optionally having a branched chain is one or two or more selected from the group consisting of 1,2-hexanediol, 4-methyl-1,2-pentanediol, and 3,3-dimethyl-1,2-butanediol.

16. The ink composition according to claim 1, wherein the water-soluble 1,3-alkane diol optionally having a branched chain is 1,3-butanediol and/or 3-methyl-1,3-butanediol.

17. The ink composition according to claim 1, wherein the alkylene glycol is dipropylene glycol.

18. The ink composition according to claim 1, wherein the amount of surfactant ranges from 0.01% to 1.0% by weight.

19. The ink composition according to claim 18, wherein the surfactant is a polyorganosiloxane surfactant.

20. The ink composition according to claim 1, wherein the amount of oxyethyl acrylate resin ranges from 1.0% to 6.0% by weight.

21. (canceled)

22. (canceled)

23. (canceled)
